(19) United States
(12) Patent Application Publication
(10) Pub. No.: US 2021/0362087 A1
(43) Pub. Date: Nov. 25, 2021

(54) NON-CIRCULAR FILTER CORE AND ROLLING METHOD THEREOF

(71) Applicant: PRO-PURE INC., New Taipei City (TW)

(72) Inventor: Hsiang-Chi LIN, New Taipei City (TW)

(73) Assignee: PRO-PURE INC., New Taipei City (TW)

(21) Appl. No.: 16/941,078

(22) Filed: Jul. 28, 2020

(30) Foreign Application Priority Data
May 20, 2020 (CN) 202010428646.5

(51) Int. Cl. B01D 46/52; B01D 46/00

(52) U.S. Cl. CPC B01D 46/527; B01D 2265/06; B01D 46/0001

(57) ABSTRACT

A rolling method of a non-circular filter core has the following steps. Adhere together a wavy filtering sheet and a flat filtering sheet. Coat an edge-sealing adhesive layer. Roll the filtering sheets. By having the edge-sealing adhesive layer with sufficient volume and width coated on a site where the filtering sheets are folded for a first time before folding, the leading edges of the filtering sheets are buried in the edge-sealing adhesive layer simultaneously after folded. As a result, the leading edges are adhered and sealed reliably to prevent fluid bypassing. The method is simple and fast, which improves efficiency and is suitable for full automation. The method further improves efficiency after fully automated by reducing an amount of production equipment that needs to be paused for manual operation and by reducing the waiting time for the manual operation.

### BACKGROUND OF THE INVENTION

### 1. Field of the Invention

The present invention relates to a non-circular filter core for removing suspended particles from fluid and a rolling method thereof, especially to a filter core of a racetrack-shaped filter cartridge used for a truck.

### 2. Description of the Prior Arts

A conventional filter cartridge comprises a filter frame and a filter core. The filter core is mounted in the filter frame, and comprises a wavy filtering sheet and a flat filtering sheet. The filtering sheets are rolled into the shape of a cylinder and are alternately stacked to form multiple axial channels, which have the same shape and size. Each of half of the channels is coated with an end-sealing adhesive layer at one axial end adjacent to an inlet of the filter core to seal said channel. Each one of the other half of the channels is coated with another end-sealing adhesive layer at the other axial end adjacent to an outlet of the filter core to seal said channel. Therefore, the fluid to be filtered enters half of the channels, flows along said half of the channels, hits the end-sealing adhesive layer adjacent to the outlet, and is forced to pass through the wavy filtering sheet and the flat filtering sheet to the other half of the channels, such that the fluid can leave the filter core. The fluid is filtered to make dusts in the fluid attached to the wavy and flat filtering sheets when the fluid is forced through the wavy and flat filtering sheets.

With reference to FIG. 15, when producing said filter core, firstly glue 93 is coated along a filtering edge 921 of the wavy filtering sheet 92 and between a top surface of the flat filtering sheet 91 and a bottom surface of the wavy filtering sheet 92 to adhere the flat filtering sheet 91 and the wavy filtering sheet 92 together and to form one of the end-sealing adhesive layers aforementioned. Then, glue is coated along a filtering edge 922 of the wavy filtering sheet 92 and on a top surface of the wavy filtering sheet 92 while the flat filtering sheet 91 and the wavy filtering sheet 92 are rolled into a cylinder. The glue along the filtering edge 922 holds the filtering sheets in a cylindrical shape and forms the other end-sealing adhesive layer aforementioned.

With reference to FIG. 16, however, the two end-sealing adhesive layers do not adhere a leading edge 911 of the flat filtering sheet 91 and a leading edge 923 of the wavy filtering sheet 92 together. The leading edge 923 of the wavy filtering sheet 92 is perpendicular to the filtering edge 921 and the filtering edge 922, and both the leading edge 911 and the leading edge 923 are located in an innermost and central area after the flat filtering sheet 91 and the wavy filtering sheet 92 are rolled into the cylindrical filter core. The leading edge 911 of the flat filtering sheet 91 and the leading edge 923 of the wavy filtering sheet 92 also need to be adhered together to form a sealed edge such that when the fluid is forced through the channel with a side wall formed by the leading edge 911 and the leading edge 923 adhered together, the fluid is completely filtered by the filtering sheets 91, 92. If the leading edge 911 and the leading edge 923 are not adhered together by the glue, then the fluid tends to pass through a gap formed between two said edges instead of being forced through any one of the filtering sheets 91, 92, which is referred to as bypassing.

However, because the leading edge 911 of the flat filtering sheet 91 and the leading edge 923 of the wavy filtering sheet 92 are only about as thick as two paper sheets, it is difficult for a machine to coat glue 94 very accurately to adhere the leading edges 911, 923 together properly. Therefore, currently the glue 94 is coated to the leading edge 911 and the leading edge 923 manually using a glue gun to coat glue 94 along the leading edges 911, 923 to adhere the leading edges 911, 923 together and seal the gap between the leading edges 911, 923. The filtering sheets 91, 92 are rolled after the gap between the leading edges 911, 923 are sealed. However, the current operating method has the following disadvantages:

Firstly, coating the glue manually means that the filter core cannot be rolled into the cylindrical shape fully automatically. That is, before each filter core, production equipment needs to be paused to wait for manual gluing process, which means more pauses and more waiting time, which lowers a production efficiency.

Secondly, even if a worker can manually coat the glue along the thin leading edges 911, 923, it is still a challenging and time-consuming process that affects the production efficiency.

Thirdly, quality of the product can be unstable due to varying proficiencies of the workers.

Fourth, a larger amount of glue is often coated during the manual gluing process to ensure the gap is properly sealed. However, the glue keeps dripping to the ground, which pollutes the working environment and causes waste of resources. Furthermore, because the glue keeps dripping to the ground may reduce sealing efficacy, it is difficult to enhance the sealing efficacy by coating more glue.

To overcome the shortcomings, the present invention provides a non-circular filter core and a rolling method thereof to mitigate or obviate the aforementioned problems.

### SUMMARY OF THE INVENTION

The main objective of the present invention is to provide a non-circular filter core and a rolling method thereof to ensure sealing efficacy of the glue and to make full automation possible.

The rolling method of a non-circular filter core has steps as follows:

(a) adhering together a wavy filtering sheet and a flat filtering sheet, wherein the flat filtering sheet used for removing suspended pollutants has a flat leading edge; the wavy filtering sheet used for removing suspended pollutants has multiple peaks, a first edge, a second edge disposed opposite to the first edge, a first surface, a second surface disposed opposite to the first surface, and a wavy leading edge; the wavy leading edge connects the first edge and the second edge; a first end-sealing adhesive layer is coated on the first surface of the wavy filtering sheet and coated along the first edge; the flat filtering sheet is adhered to the first surface of the wavy filtering sheet via the first end-sealing adhesive layer;

(b) coating an edge-sealing adhesive layer, wherein a second end-sealing adhesive layer and the edge-sealing adhesive layer are coated on the second surface of the wavy filtering sheet; the second end-sealing adhesive layer is coated along the second edge of the wavy filtering sheet; two ends of the edge-sealing adhesive layer extend toward the first edge and the second edge respectively; the edge-sealing adhesive layer is connected to the second end-sealing adhesive layer;

(c) rolling, wherein the wavy filtering sheet and the flat filtering sheet are folded in a direction in which the wavy leading edge and the flat leading edge are toward the edge-sealing adhesive layer, and the wavy leading edge and the flat leading edge are buried in the edge-sealing adhesive layer to adhere together the wavy leading edge and the flat leading edge; then the wavy filtering sheet and the flat filtering sheet are rolled such that the wavy filtering sheet and the flat filtering sheet are alternately stacked, and the second end-sealing adhesive layer keeps the wavy filtering sheet and the flat filtering sheet alternately stacked.

The non-circular filter core has a flat filtering sheet, a wavy filtering sheet, a first end-sealing adhesive layer, a second end-sealing adhesive layer, and an edge-sealing adhesive layer. The flat filtering sheet is used for removing suspended pollutants and has a leading edge. The wavy filtering sheet is used for removing suspended pollutants and has multiple peaks, a first edge, a second edge disposed opposite to the first edge, a first surface, a second surface disposed opposite to the first surface, and a wavy leading edge connecting the first edge and the second edge. The first end-sealing adhesive layer is coated on the first surface of the wavy filtering sheet and along the first edge. The second end-sealing adhesive layer is coated on the second surface of the wavy filtering sheet and along the second edge. The edge-sealing adhesive layer is coated on the second surface of the wavy filtering sheet. A first end and a second end of the edge-sealing adhesive layer extend toward the first edge and the second edge respectively. The edge-sealing adhesive layer is connected to the second end-sealing adhesive layer. The flat filtering sheet is adhered to the first surface of the wavy filtering sheet via the first end-sealing adhesive layer. The wavy filtering sheet and the flat filtering sheet are rolled such that the wavy filtering sheet and the flat filtering sheet are alternately stacked and adhered together via the second end-sealing adhesive layer. The wavy leading edge and the flat leading edge are buried in the edge-sealing adhesive layer to adhere together the wavy leading edge and the flat leading edge.

The advantage of the present invention is that the edge-sealing adhesive layer with sufficient volume and width is coated on a site where the two filtering sheets are folded for a first time before the two filtering sheets are folded. As a result, after the two filtering sheets are folded for the first time, the two leading edges of the two filtering sheets are buried in the edge-sealing adhesive layer simultaneously to effectively adhere the two leading edges together, thereby preventing bypassing.

Furthermore, unlike the conventional method, which coats glue to peripheries (leading edges) of the two filtering sheets and results in dripping of the glue, the edge-sealing adhesive layer is coated on a surface of the wavy filtering sheet. Even if a larger amount of glue is coated, the glue does not overflow from the leading edge to the ground, ensuring that the glue enhances the sealing efficacy instead of dripping to the ground, polluting the working environment, and having no effect on improving sealing as the glue in the conventional method does.

Moreover, by merely coating the edge-sealing adhesive layer on a specific location of a surface of the wavy filtering sheet, the leading edges can be automatically adhered together after folding. As a result, coating the edge-sealing adhesive layer is simple and fast, which improves efficiency and can be done by a machine instead of by human workers. Therefore, the present invention can easily be automated to reduce an amount of production equipment that needs to be paused for manual operation and to reduce the waiting time for manual operation, thereby further improving efficiency. Finally, by reducing manual operation, which is unstable due to varying proficiencies of the workers, quality of the product can be improved.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a machine utilizing a rolling method of a non-circular filter core in accordance with the present invention;

FIG. 2 is a schematic perspective view of the rolling method of a non-circular filter core, showing two filtering sheets being adhered together;

FIG. 3 is another schematic perspective view of the rolling method of a non-circular filter core, showing an edge-sealing adhesive layer coated on a filtering sheet;

FIGS. 4 to 6 are top views of the rolling method of a non-circular filter core, showing different operating statuses of coating the edge-sealing adhesive layer;

FIGS. 7 to 9 are top views of the rolling method of a non-circular filter core, showing different operating statuses of rolling the filtering sheets;

FIG. 10 is a schematic side view of the rolling method of a non-circular filter core, showing the filtering sheets after folded for a first time;

FIG. 11 is a schematic side view in partial section of FIG. 10;

FIG. 12 is an end view of a finished product made by the rolling method of a non-circular filter core;

FIG. 13 is a flow chart of the rolling method of a non-circular filter core;

FIG. 14 is a schematic view in comparison of another embodiment of a rolling method of a non-circular filter core;

FIG. 15 is a schematic perspective view of a conventional rolling method of a filter core, showing glue coated on two leading edges of two filtering sheets; and

FIG. 16 is a schematic perspective view in partial section of FIG. 15.

### DETAILED DESCRIPTION OF THE PREFERRED EMBODIMENTS

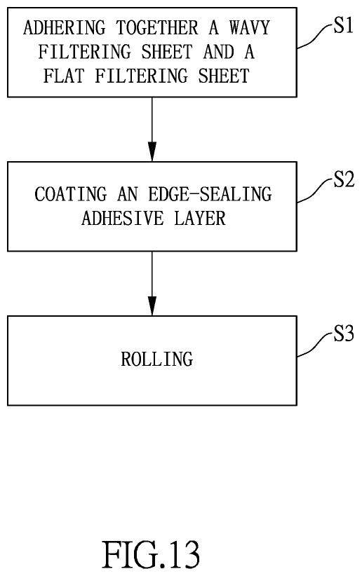

With reference to FIG. 13, a rolling method of a non-circular filter core in accordance with the present invention comprises the following steps: the first step (S1) is adhering together a wavy filtering sheet and a flat filtering sheet; the second step (S2) is coating an edge-sealing adhesive layer; the third step (S3) is rolling. The non-circular filter core of the present invention is preferably, but not limited to, a racetrack-shaped filter core. The non-circular filter core can be of any other non-circular shape such as an ellipsoid.

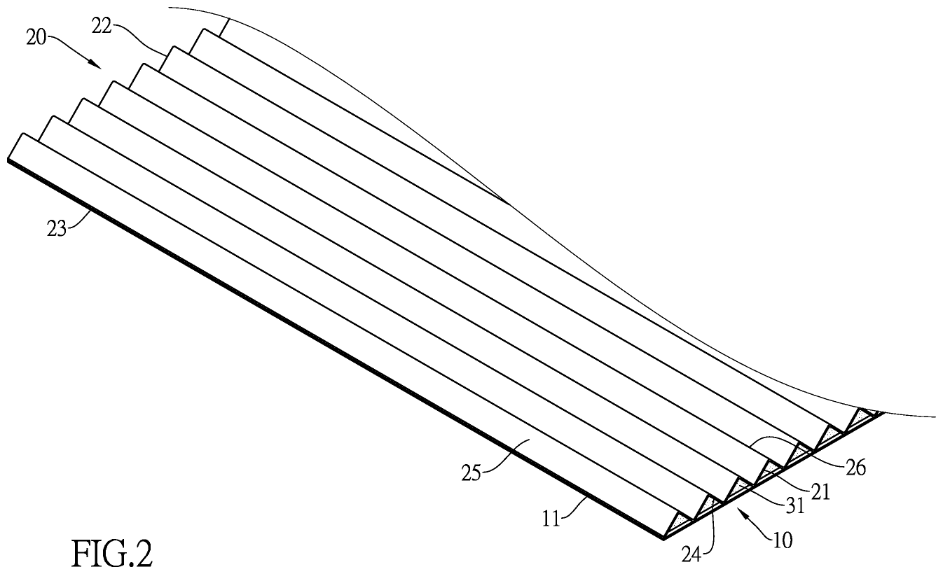

The first step (S1) is adhering together a wavy filtering sheet and a flat filtering sheet. With reference to FIG. 2, a flat filtering sheet 10 and a wavy filtering sheet 20 used for removing suspended pollutants are prepared. An edge of the flat filtering sheet 10 toward a length direction is a flat leading edge 11. An edge of the wavy filtering sheet 20 toward the length direction is a wavy leading edge 23. Furthermore, the wavy filtering sheet 20 has a first edge 21 and a second edge 22 disposed opposite each other. The wavy leading edge 23 connects the first edge 21 and the second edge 22. The wavy leading edge 23 is preferably perpendicular to the first edge 21 and the second edge 22, but not limited thereto. The wavy filtering sheet 20 has a first surface 24 and a second surface 25 disposed opposite each other, and multiple peaks 26 protruding from the first surface 24 and the second surface 25.

A first end-sealing adhesive layer 31 is coated on a first surface 24 of the wavy filtering sheet 20 and coated along the first edge 21. The flat filtering sheet 10 is adhered to the first surface 24 of the wavy filtering sheet 20 via the first end-sealing adhesive layer 31. Note that the first end-sealing adhesive layer 31 coated along the first edge 21 does not mean that the first end-sealing adhesive layer 31 is in close proximity or attached to the first edge 21. Rather, it means that a coating direction of the first end-sealing adhesive layer 31 is aligned with an extending direction of the first edge 21, but the coating direction of the first end-sealing adhesive layer 31 does not have to be exactly aligned with the extending direction of the first edge 21. In the preferred embodiment, the first end-sealing adhesive layer 31 is disposed apart from the first edge 21, and the coating direction of the first end-sealing adhesive layer 31 is parallel to the extending direction of the first edge 21.

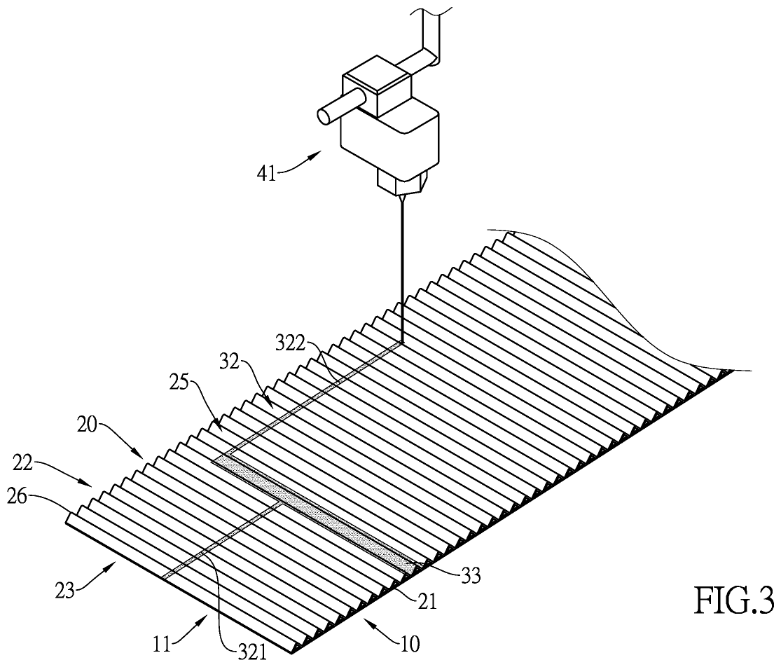

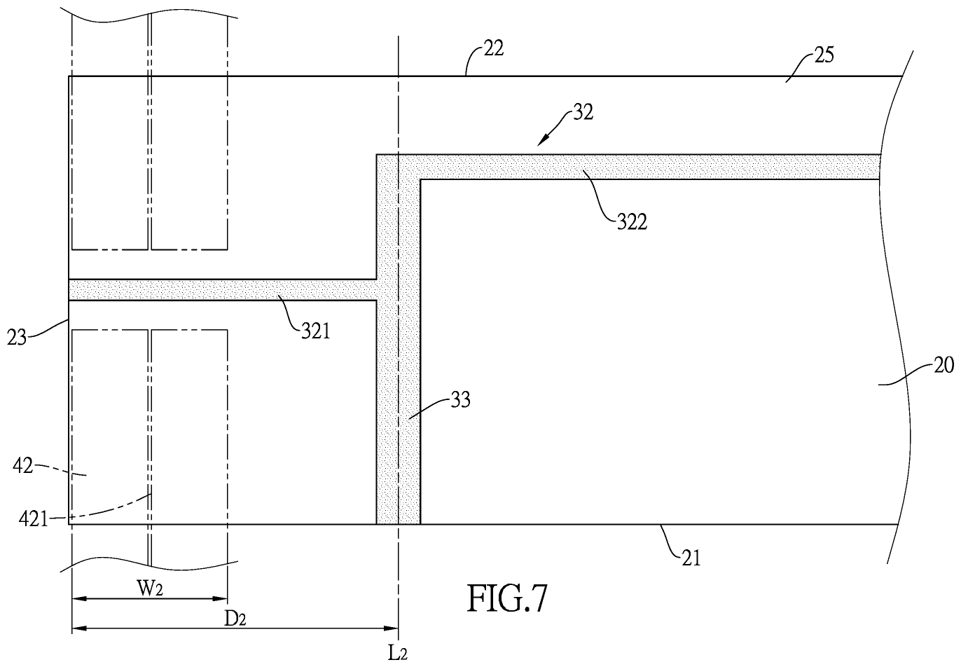

The second step (S2) is coating the edge-sealing adhesive layer. With reference to FIG. 3 and FIG. 7, a second end-sealing adhesive layer 32 and an edge-sealing adhesive layer 33 are coated on the second surface 25 of the wavy filtering sheet 20. The second end-sealing adhesive layer 32 is coated along the second edge 22 of the wavy filtering sheet 20. Same as aforementioned, the second end-sealing adhesive layer 32 does not have to be in close proximity or attached to the second edge 22. Two ends of the edge-sealing adhesive layer 33 extend toward the first edge 21 and the second edge 22 respectively. The edge-sealing adhesive layer 33 is connected to the second end-sealing adhesive layer 32.

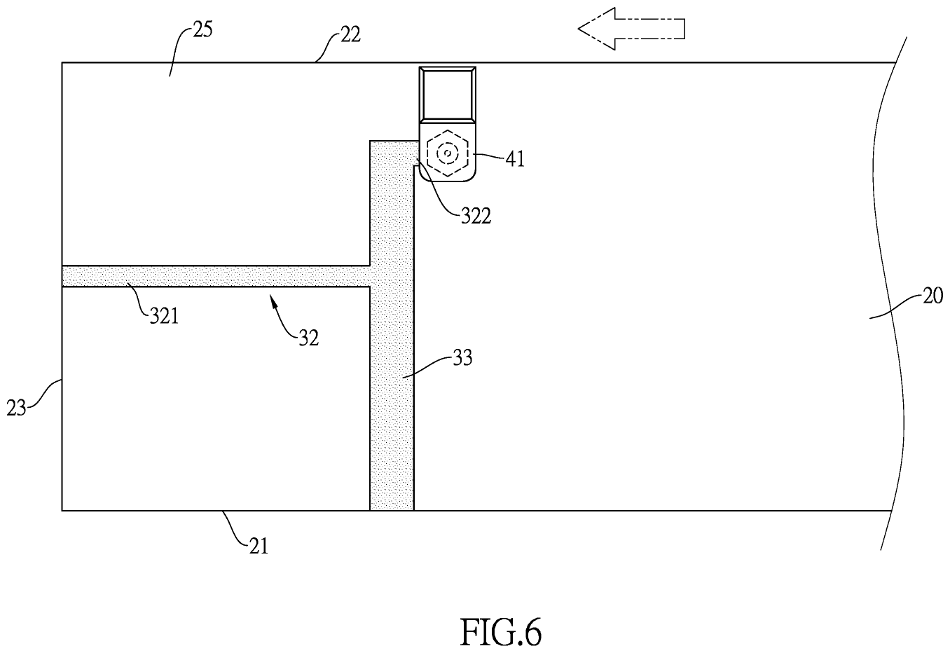

The two ends of the edge-sealing adhesive layer 33 extend toward the first edge 21 and the second edge 22 respectively, but this does not mean that the two ends of the edge-sealing adhesive layer 33 extend to the reach the first edge 21 and the second edge 22 respectively. Rather, it indicates a coating direction of the edge-sealing adhesive layer 33, which is preferably perpendicular to the first edge 21 and the second edge 22, but it is not limited thereto. With reference to FIG. 3 and FIG. 6, in the preferred embodiment, the two ends of the edge-sealing adhesive layer 33 are a first end and a second end respectively. The first end extends to the first edge 21. The second end extends to the second end-sealing adhesive layer 32 and is disposed apart from the second edge 22.

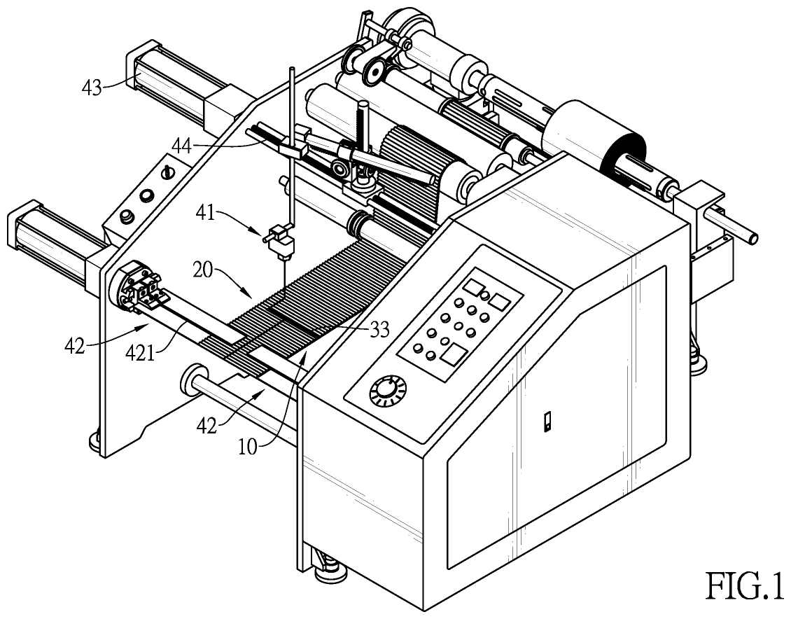

With reference to FIGS. 1, 3, and 5, in the preferred embodiment, a glue gun 41 is used for coating the edge-sealing adhesive layer 33 and the second end-sealing adhesive layer 32. The flat filtering sheet 10 and the wavy filtering sheet 20 can be moved toward the flat leading edge 11 or the wavy leading edge 23, and therefore the glue gun 41 only needs to be moved along an imaginary straight line connecting the first edge 21 and the second edge 22. For example, a servo motor 43 and a leadscrew 44 are sufficient for moving the glue gun 41. The glue gun 41 does not require a positioning system which is capable of moving the glue gun 41 along two axes, but it is not limited thereto. In another preferred embodiment, the glue gun 41 can be designed to be moved along two axes.

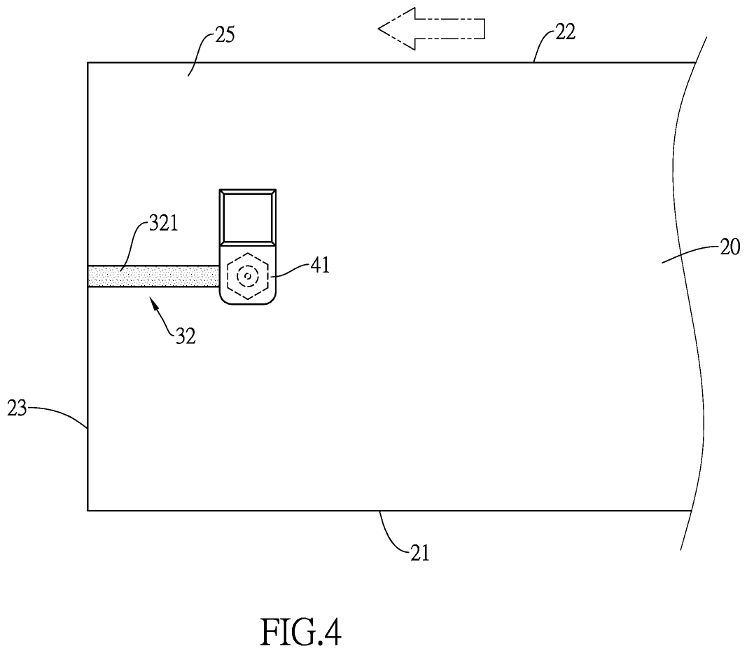

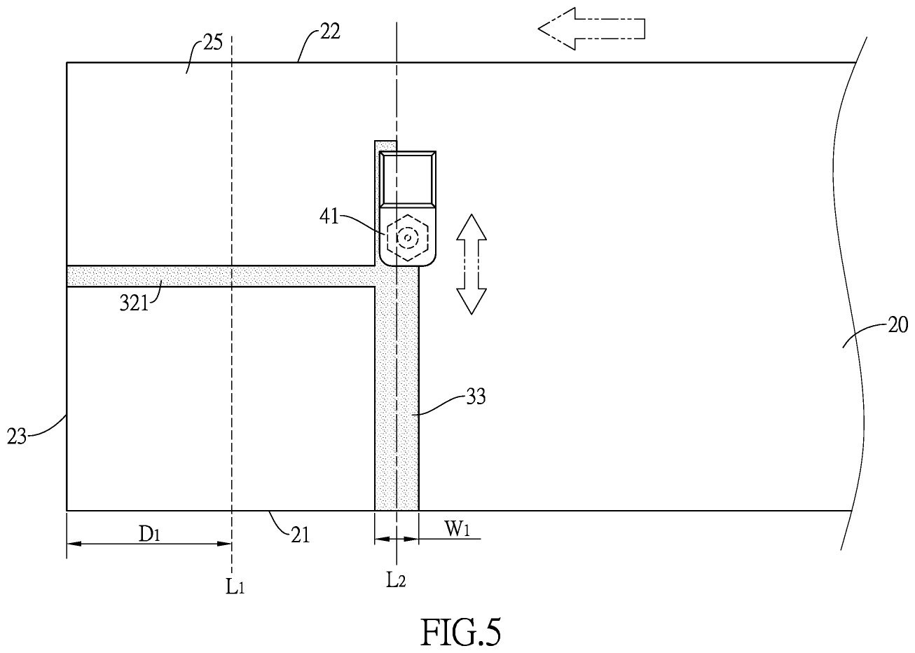

With reference to FIG. 4, when coating the edge-sealing adhesive layer 33, the glue gun 41 is moved to the wavy leading edge 23 between the first edge 21 and the second edge 22 and then remains stationary. Then, the flat filtering sheet 10 and the wavy filtering sheet 20 are moved together toward the flat leading edge 11 and the wavy leading edge 23 while the glue gun 41 dispenses glue continuously, making glue from the glue gun 41 extend from the wavy leading edge 23 of the wavy filtering sheet 20. With reference to FIG. 5, a distance between the wavy leading edge 23 and a first folding line L1 is defined as a first distance D1. The flat filtering sheet 10 and the wavy filtering sheet 20 are moved together until a distance between the glue gun 41 and the wavy leading edge 23 is two times as long as the first distance D1. At this moment, the glue gun 41 is also located above a middle line L2 of the edge-sealing adhesive layer 33. A first section 321 of the second end-sealing adhesive layer 32 is formed during said process.

Then, the glue gun 41 is moved toward the first edge 21 while dispensing glue continuously. Then, the flat filtering sheet 10 and the wavy filtering sheet 20 are moved together a little bit toward the flat leading edge 11 and the wavy leading edge 23 before changing a moving direction of the glue gun 41 toward the second edge 22. The glue gun 41 keeps dispensing glue while being moved toward the second edge 22 to form the edge-sealing adhesive layer 33. In another preferred embodiment, the process that the flat filtering sheet 10 and the wavy filtering sheet 20 are moved together a little bit toward the flat leading edge 11 before changing the moving direction of the glue gun 41 can be omitted.

In the preferred embodiment, a width of the edge-sealing adhesive layer 33 is increased by moving the glue gun 41 back and forth. In another preferred embodiment, the width of the edge-sealing adhesive layer 33 can be increased via other ways such as increasing a glue output rate of the glue gun 41. Besides, the width of the edge-sealing adhesive layer 33 can be smaller when a position accuracy of the glue is increased. In the preferred embodiment, a width W1 of the edge-sealing adhesive layer 33 is roughly two times as long as a width of one of the peaks. The width of one peak is defined as a distance between two of the peaks that are adjacent to each other. In the preferred embodiment, the width of one peak is from 5 millimeters to 10 millimeters, and preferably 7.8 millimeters. Therefore, the width W1 of the edge-sealing adhesive layer 33 is from 10 millimeters to 20 millimeters, and preferably 15.6 millimeters, but not limited thereto.

With reference to FIG. 6, finally, the glue gun 41 remains stationary while the flat filtering sheet 10 and the wavy filtering sheet 20 move together toward the flat leading edge 11 and the wavy leading edge 23. The glue gun 41 keeps dispensing while the flat filtering sheet 10 and the wavy filtering sheet 20 are moved to form a second section 322 of the second end-sealing adhesive layer 32. In another preferred embodiment, said process can be achieved by mounting the glue gun 41 on the positioning system which is capable of moving the glue gun 41 along two axes.

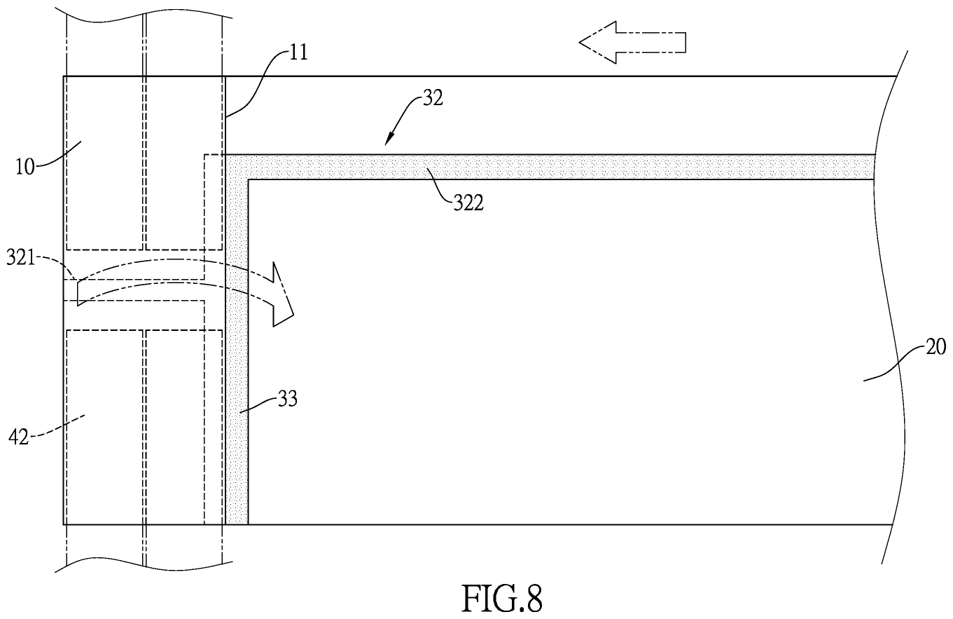

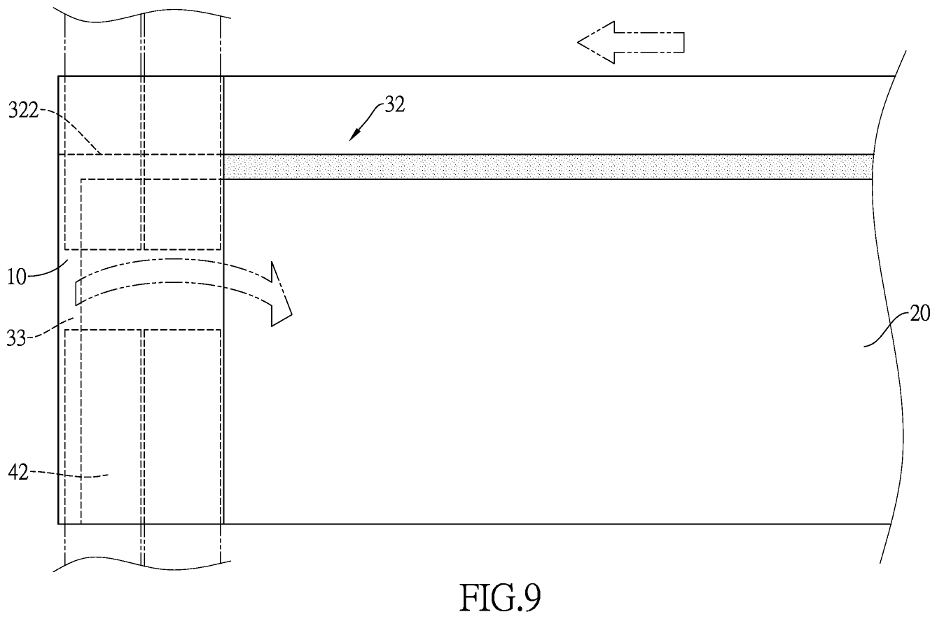

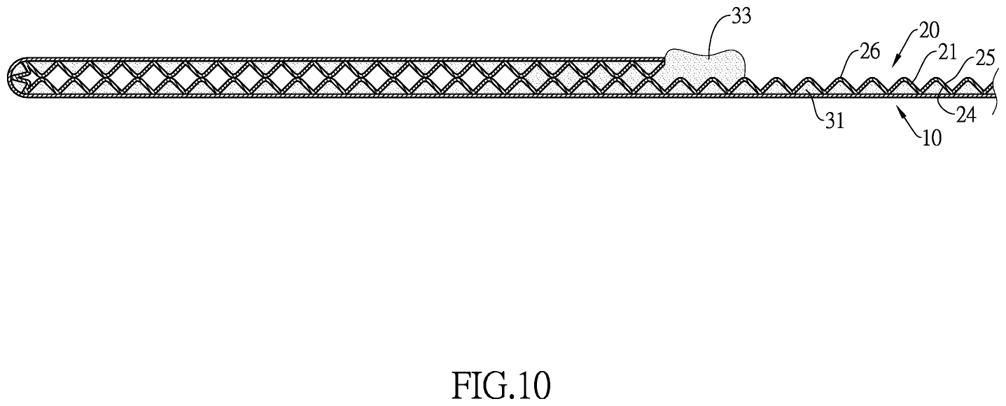

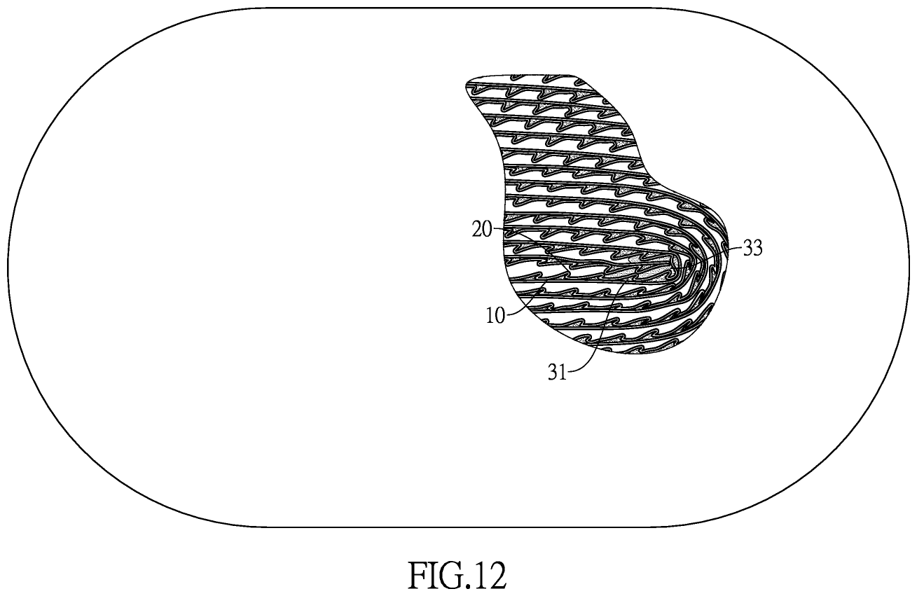

The third step (S3) is rolling. With reference to FIGS. 7, 8, and 10, the wavy filtering sheet 20 and the flat filtering sheet 10 are folded in a direction in which the wavy leading edge 23 and the flat leading edge 11 are toward the edge-sealing adhesive layer 33, and the wavy leading edge 23 and the flat leading edge 11 are buried in the edge-sealing adhesive layer 33 to adhere the wavy leading edge 23 and the flat leading edge 11 together. With reference to FIGS. 8, 9, and 12, then the wavy filtering sheet 20 and the flat filtering sheet 10 are folded repeatedly such that the wavy filtering sheet 20 and the flat filtering sheet 10 are rolled in an alternately stacked manner, and the second end-sealing adhesive layer 32 keeps the wavy filtering sheet and the flat filtering sheet rolled in an alternately stacked manner. Forming of the filter core has been completed. At the moment, two ends of the filter core are an inlet and an outlet respectively. The first edge 21 of the wavy filtering sheet 20 can be the inlet or the outlet of the filter core depending on the actual situation.

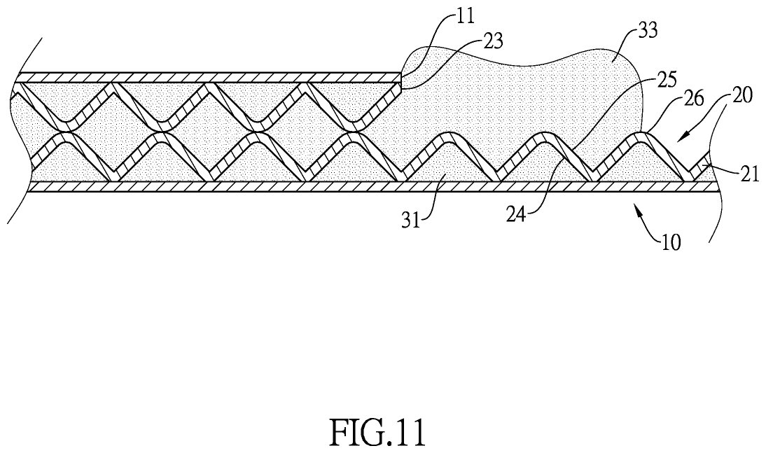

With reference to FIG. 8 and FIG. 11, the wavy leading edge 23 and the flat leading edge 11 buried in the edge-sealing adhesive layer 33 as mentioned above mean that the edge-sealing adhesive layer 33 extends along the extending direction of the first edge 21 to two sides of the flat leading edge 11 and the wavy leading edge 23 (as shown in FIG. 11, said two sides being left side and right side respectively). The flat leading edge 11 and the wavy leading edge 23 do not have to be in an exact middle of the edge-sealing adhesive layer 33, but in the preferred embodiment, the flat leading edge 11 and the wavy leading edge 23 are buried in the exact middle of the edge-sealing adhesive layer 33. With reference to FIG. 7, the exact middle of the edge-sealing adhesive layer 33 is depicted by the middle line L2.

With reference to FIGS. 1, 7, and 8, in the preferred embodiment, the wavy filtering sheet 20 and the flat filtering sheet 10 are clamped by two panel-clamps 42 from the first edge 21 and the second edge 22 respectively. Each one of the panel-clamps 42 has a slit 421, and the slit 421 is formed in a middle of the panel-clamp 42. The flat filtering sheet 10 and the wavy filtering sheet 20 are mounted through the slit 421 of each one of the panel-clamps 42. A distance between a middle of the edge-sealing adhesive layer 33 and the wavy leading edge 23 is defined as a second distance D2. With reference to FIG. 7, a width W2 of each one of the panel-clamps 42 corresponds to half of the second distance D2, meaning that the width W2 of each one of the panel-clamps 42 is equal to or slightly smaller than half of the second distance D2. Shape and size of the panel-clamps 42 can be altered as long as the panel-clamps 42 are capable of making the flat leading edge 11 and the wavy leading edge 23 buried in the edge-sealing adhesive layer 33 after the flat filtering sheet 10 and the wavy filtering sheet 20 are folded for the first time. In a preferred embodiment, the second end-sealing adhesive layer 32 includes the first section 321 and the second section 322. The first section 321 is more distant from the second edge 22 than the second section 322 is, which prevents the panel-clamps 42 from being adhered by glue from the first section 321 of the second end-sealing adhesive layer 32 when the panel-clamps 42 hold the flat filtering sheet 10 and the wavy filtering sheet 20. If the flat filtering sheet 10 and the wavy filtering sheet 20 are folded and rolled in another way, the second end-sealing adhesive layer 32 can be a straight line without having the first section 321 and the second section 322.

Besides, the flat leading edge 11 and the wavy leading edge 23 do not have to be buried in the edge-sealing adhesive layer 33 completely. As mentioned above, the first end and the second end of the edge-sealing adhesive layer 33 can be disposed apart from the first edge 21 and the second edge 22 respectively such that only part of the flat leading edge 11 and the wavy leading edge 23 are buried in the edge-sealing adhesive layer 33 and adhered together. The edge-sealing adhesive layer 33 has to extend toward the second edge 22 only to the second end-sealing adhesive layer 32 because a region beyond the second end-sealing adhesive layer 32 has no effect on filtering, thereby having no problem of bypassing.

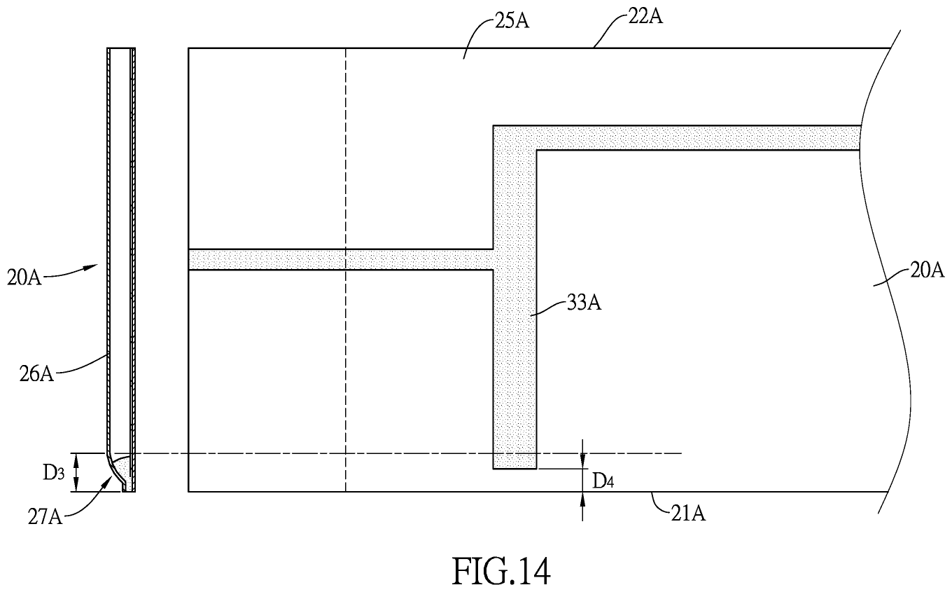

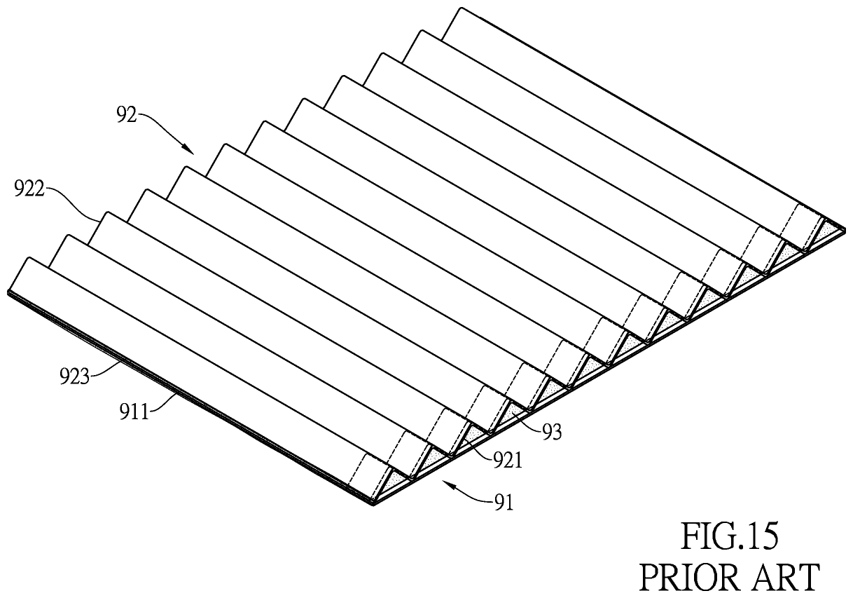

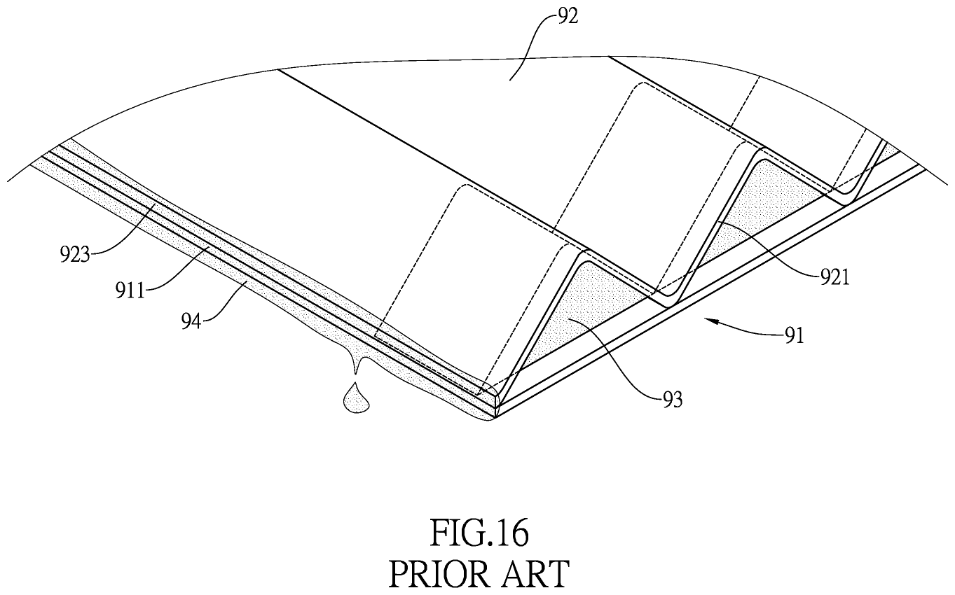

With reference to FIG. 14, in another preferred embodiment, the first end of the edge-sealing adhesive layer 33A is disposed apart from the first edge 21A. A distance between the first end of the edge-sealing adhesive layer 33A and the first edge 21A is defined as an interval distance D4. The interval distance D4 is preferably from 3 millimeters to 10 millimeters, wherein 3 millimeters and 10 millimeters are included. A range of the interval distance D4 is not limited thereto. The reason why the edge-sealing adhesive layer 33A does not have to extend to the first edge 21A is because a pressing region 27A is formed on the second surface 25A. The pressing region 27A extends along the first edge 21A, and extends to part of the first end-sealing adhesive layer from the first edge 21A. The peaks 26A in the pressing region 27A are pressed to lean clockwise or counterclockwise together.

A pressing distance D3 is defined as a distance by which the pressing region 27A extends from the first edge 21A toward the second edge 22A. An interval distance D4 is defined as a distance between the first edge 21A and the first end of the edge-sealing adhesive layer 33A; the pressing distance D3 is equal to or greater than the interval distance D4. In the preferred embodiment, the pressing distance D3 is preferably from 5 millimeters to 10 millimeters, wherein 5 millimeters and 10 millimeters are included, but not limited thereto.

In other words, the first end of the edge-sealing adhesive layer 33A is closer to the first edge 21A than a periphery of the pressing region 27A is. Because the peaks 26A in the pressing region 27A are pressed down, fluid is naturally bypassed when the fluid reaches the pressing region 27A of an axial channel, and therefore it is unnecessary to extend the edge-sealing adhesive layer 33A to the first edge 21A. The edge-sealing adhesive layer 33A only has to extend toward the first edge 21A such that the first end of the edge-sealing adhesive layer 33A is aligned with the pressing region 27A or that said first end is closer to the first edge 21A than the pressing region 27A is.

With reference to FIG. 2 and FIG. 11, in the preferred embodiment, when the flat filtering sheet 10 and the wavy filtering sheet 20 are adhered together, the flat leading edge 11 and the wavy leading edge 23 are preferably aligned, but not limited thereto. The flat leading edge 11 and the wavy leading edge 23 can be slightly spaced apart from each other or be non-parallel to each other as long as the flat leading edge 11 and wavy leading edge 23 are adhered together by the edge-sealing adhesive layer 33 after buried therein, and a gap formed between the flat leading edge 11 and the wavy leading edge 23 is sealed.

A non-circular filter core in accordance with the present invention is identical to the aforementioned filter core of the rolling method. Structure of the filter core is already explained in the aforementioned steps of the rolling method, and thus the detailed structure of the filter core is not repeated.

By having the edge-sealing adhesive layer 33 with sufficient volume and width coated on a site where the filtering sheets are folded for a first time before the filtering sheets are folded, the flat leading edge 11 of the flat filtering sheet 10 and the wavy leading edge 23 of the wavy filtering sheet 20 are then buried in the edge-sealing adhesive layer 33. As a result, the flat leading edge 11 and the wavy leading edge 23 are adhered together effectively to avoid fluid bypassing.

Furthermore, the edge-sealing adhesive layer 33 is coated on a surface (second surface 25) of the wavy filtering sheet 20. Even if a larger amount of glue is coated, the glue does not overflow from the flat leading edge 11 and the wavy leading edge 23. Therefore, the edge-sealing adhesive layer 33 can effectively enhance the sealing efficacy and keep a working environment clean.

Moreover, by merely coating the edge-sealing adhesive layer 33 on a specific location of a surface (second surface 25) of the wavy filtering sheet 20, the leading edges can be automatically adhered together after folding. Therefore, coating the edge-sealing adhesive layer 33 is simple and fast, which improves efficiency and can be done by a machine instead of by human workers. As a result, the present invention can easily be automated to reduce an amount of production equipment that needs to be paused for manual operating and to reduce the waiting time for the manual operation, thereby further improving efficiency. Finally, by reducing manual operation, which is unstable due to varying proficiencies of the workers, quality of the product can be improved.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A rolling method of a non-circular filter core comprising steps as follows:
(a) adhering together a wavy filtering sheet and a flat filtering sheet, wherein the flat filtering sheet used for removing suspended pollutants has a flat leading edge; the wavy filtering sheet used for removing suspended pollutants has multiple peaks, a first edge, a second edge disposed opposite to the first edge, a first surface, a second surface disposed opposite to the first surface, and a wavy leading edge; the wavy leading edge connects the first edge and the second edge; a first end-sealing adhesive layer is coated on the first surface of the wavy filtering sheet and coated along the first edge; the flat filtering sheet is adhered to the first surface of the wavy filtering sheet via the first end-sealing adhesive layer;
(b) coating an edge-sealing adhesive layer, wherein a second end-sealing adhesive layer and the edge-sealing adhesive layer are coated on the second surface of the wavy filtering sheet; the second end-sealing adhesive layer is coated along the second edge of the wavy filtering sheet; two ends of the edge-sealing adhesive layer extend toward the first edge and the second edge respectively; the edge-sealing adhesive layer is connected to the second end-sealing adhesive layer;
(c) rolling, wherein the wavy filtering sheet and the flat filtering sheet are folded in a direction in which the wavy leading edge and the flat leading edge are toward the edge-sealing adhesive layer, and the wavy leading edge and the flat leading edge are buried in the edge-sealing adhesive layer to adhere together the wavy leading edge and the flat leading edge; then the wavy filtering sheet and the flat filtering sheet are rolled such that the wavy filtering sheet and the flat filtering sheet are alternately stacked, and the second end-sealing adhesive layer keeps the wavy filtering sheet and the flat filtering sheet alternately stacked.

2. The rolling method as claimed in claim 1, wherein in step (c), the wavy leading edge and the flat leading edge are buried in a middle of the edge-sealing adhesive layer.

3. The rolling method as claimed in claim 1, wherein in step (c), two panel-clamps clamp the wavy filtering sheet and the flat filtering sheet from the first edge and the second edge respectively; a width of each one of the panel-clamps corresponds to half of a distance between a middle of the edge-sealing adhesive layer and the wavy leading edge.

4. The rolling method as claimed in claim 2, wherein in step (c), two panel-clamps clamp the wavy filtering sheet and the flat filtering sheet from the first edge and the second edge respectively; a width of each one of the panel-clamps corresponds to half of a distance between the middle of the edge-sealing adhesive layer and the wavy leading edge.

5. The rolling method as claimed in claim 3, wherein in step (c), each one of the panel-clamps has a slit, and the slit is formed in a middle of the panel-clamp; the flat filtering sheet and the wavy filtering sheet are mounted through the slit of each one of the panel-clamps.

6. The rolling method as claimed in claim 4, wherein in step (c), each one of the panel-clamps has a slit, and the slit is formed in a middle of the panel-clamp; the flat filtering sheet and the wavy filtering sheet are mounted through the slit of each one of the panel-clamps.

7. The rolling method as claimed in claim 1, wherein in step (b), a glue gun is moved toward the first edge and dispenses glue simultaneously, and then the glue gun is moved toward the second edge and dispenses glue simultaneously to form the edge-sealing adhesive layer; then, the wavy filtering sheet and the flat filtering sheet are moved together toward the wavy leading edge and the flat leading edge while the glue gun, which remains stationary, dispenses glue to form the second end-sealing adhesive layer.

8. The rolling method as claimed in claim 6, wherein in step (b), a glue gun is moved toward the first edge and dispenses glue simultaneously, and then the glue gun is moved toward the second edge and dispenses glue simultaneously to form the edge-sealing adhesive layer; then, the wavy filtering sheet and the flat filtering sheet are moved together toward the wavy leading edge and the flat leading edge while the glue gun, which remains stationary, dispenses glue to form the second end-sealing adhesive layer.

9. The rolling method as claimed in claim 7, wherein in step (b), after the glue gun is moved toward the first edge and dispenses glue simultaneously, the flat filtering sheet and the wavy filtering sheet are moved together toward the flat leading edge and the wavy leading edge; then the flat filtering sheet and the wavy filtering sheet stop moving and the glue gun is moved toward the second edge and dispenses glue simultaneously to form the edge-sealing adhesive layer.

10. The rolling method as claimed in claim 8, wherein in step (b), after the glue gun is moved toward the first edge and dispenses glue simultaneously, the flat filtering sheet and the wavy filtering sheet are moved together toward the flat leading edge and the wavy leading edge; then the flat filtering sheet and the wavy filtering sheet stop moving and the glue gun is moved toward the second edge and dispenses glue simultaneously to form the edge-sealing adhesive layer.

11. A non-circular filter core comprising:
a flat filtering sheet used for removing suspended pollutants having
a leading edge;
a wavy filtering sheet used for removing suspended pollutants having
multiple peaks;
a first edge;
a second edge disposed opposite to the first edge;
a first surface;
a second surface disposed opposite to the first surface; and
a wavy leading edge connecting the first edge and the second edge;
a first end-sealing adhesive layer coated on the first surface of the wavy filtering sheet and along the first edge;
a second end-sealing adhesive layer coated on the second surface of the wavy filtering sheet and along the second edge; and
an edge-sealing adhesive layer coated on the second surface of the wavy filtering sheet; a first end and a second end of the edge-sealing adhesive layer extending toward the first edge and the second edge respectively; the edge-sealing adhesive layer connected to the second end-sealing adhesive layer;
wherein
the flat filtering sheet is adhered to the first surface of the wavy filtering sheet via the first end-sealing adhesive layer;
the wavy filtering sheet and the flat filtering sheet are rolled such that the wavy filtering sheet and the flat filtering sheet are alternately stacked and adhered together via the second end-sealing adhesive layer;
the wavy leading edge and the flat leading edge buried in the edge-sealing adhesive layer to adhere together the wavy leading edge and the flat leading edge.

12. The non-circular filter core as claimed in claim 11, wherein the first end of the edge-sealing adhesive layer extends to reach the first edge.

13. The non-circular filter core as claimed in claim 11, wherein the first end of the edge-sealing adhesive layer is disposed apart from the first edge.

14. The non-circular filter core as claimed in claim 13, wherein
a pressing region is formed on the second surface of the wavy filtering sheet; the pressing region extends along the first edge and extends to part of the first end-sealing adhesive layer from the first edge; the peaks in the pressing region are pressed to lean clockwise or counterclockwise together;
a pressing distance is defined as a distance by which the pressing region extends from the first edge toward the second edge; an interval distance is defined as a distance between the first edge and the first end of the edge-sealing adhesive layer; the pressing distance is equal to or greater than the interval distance.

15. The non-circular filter core as claimed in claim 11, wherein the second end of the edge-sealing adhesive layer extends to reach the second end-sealing adhesive layer.

16. The non-circular filter core as claimed in claim 14, wherein the second end of the edge-sealing adhesive layer extends to the second end-sealing adhesive layer.

17. The non-circular filter core as claimed in claim 11, wherein before the wavy filtering sheet and the flat filtering sheet are rolled, a width of the edge-sealing adhesive layer is from 10 millimeters to 20 millimeters.

18. The non-circular filter core as claimed in claim 16, wherein before the wavy filtering sheet and the flat filtering sheet are alternately stacked, a width of the edge-sealing adhesive layer is from 10 millimeters to 20 millimeters.

19. The non-circular filter core as claimed in claim 11, wherein
the second end-sealing adhesive layer has
a first section extending to reach the wavy leading edge; and
a second section; wherein
a distance between the first section and the second edge is greater than a distance between the second section and the second edge;
the edge-sealing adhesive layer is located between the first section and the second section, and connects the first section and the second section.

20. The non-circular filter core as claimed in claim 18, wherein
the second end-sealing adhesive layer has
a first section extending to reach the wavy leading edge; and
a second section; wherein
a distance between the first section and the second edge is greater than a distance between the second section and the second edge;
the edge-sealing adhesive layer is located between the first section and the second section, and connects the first section and the second section.
